(19) United States
(12) Patent Application Publication
(10) Pub. No.: US 2006/0119055 A1
(43) Pub. Date: Jun. 8, 2006

(54) Adjustable span snowboard stability and dampening system

(75) Inventor: Adam Heidlebaugh, Wenatchee, WA (US)

Correspondence Address: James E. Parris, P.O. Box 233, Hailey, ID, 83333, US

(73) Assignee: Xzist Technology, LLC.

(21) Appl. No.: 11/003,957

(22) Filed: Dec. 3, 2004

(51) Int. Cl. B62B 17/00

(52) U.S. Cl. 280/14.22

(57) ABSTRACT

An adjustable span snowboard stability and dampening system comprising a pair of stabilizing bars positioned in a cross configuration having ends for inserting to sockets of four retention housings mounted about two pivot plates secured to a snowboard for coplanar holding of a pair of snowboard bindings dampened by compression rings inserted between the pivot plates and the snowboard.

### BACKGROUND OF INVENTION

1. Field of Invention

The current invention relates to improving snowboard riding stability and comfort, and more particularly, is an adjustable span snowboard stability and dampening system for connecting a pair of snowboard bindings attached to a snowboard, and having elastic compressible material inserted between the system and snowboard for improving stability and comfort while snowboarding.

2. Discussion of Prior Art

Snowboarding has become a popular winter sport in recent years and is spawning new innovation as greater performance and comfort demands are made on existing technologies. A snowboard generally comprises a planar semi-flexible material for gliding across snow, where the snowboard bends and flexes according to the terrain features or according to forces exerted on the snowboard by the operator. The snowboard operator transfers their weight in lateral and transverse directions to exert forces on the snowboard for steering, stopping and the like. These forces can cause undesirable contortions in the orientation between the bindings, where it is desirable to maintain the bindings in a relatively coplanar orientation with respect to each other. For example, as a snowboard is turned there exists a tendency for a snowboard to twist due to limitations in snowboard rigidity, causing the snowboard riding surface to be less predictable. Additionally, lifting a leading foot while pressing the trailing foot can cause bowed contortion in the snowboard binding orientation.

It is generally undesirable for a snowboard to be too flexible or too rigid. A problem exists where a flexible snowboard enables a comfortable and forgiving ride, yet compromises performance and stability due to undesirable twisting and bowing between the snowboard bindings. Alternatively, a problem exists where a rigid snowboard enables higher performance, yet compromises are made in riding comfort. There is a strong need for a device that enables high performance and comfort while snowboarding.

It is desirable to snowboarders to be able to rapidly transfer their weight from one snowboard edge to another for swift turns, or it is desirable to remain on a single edge to make larger sweeping turns without distortions in the binding pair orientation. Often times a snowboarder will impart forces on the heel or toe of one binding and simultaneously imparting counter forces on the toe or heel of the opposite binding causing distortions in the binding orientation, where the applied forces are not fully realized but lost in the work applied to distort the snowboard and binding orientation. Tremendous forces are imparted on the snowboard during operation by the terrain and operator, where contortions in the snowboard cause distortions in the binding orientation having the undesirable effect of adding more operational dynamics for the operator to manage. Further, it is desirable to snowboarders to minimize interference between snowboard boots and the gliding surface, where it is common for snowboard boots to be larger than the snowboard width and thus overhang the snowboard edges.

Attempts have been made to promote torsion stability in a snowboard by embedding into the snowboard a torque-resistant or bow-resistant structure. U.S. Pat. Nos. 6,293,567 and 6,494,467 to Menges appears to disclose an imbedded structurally reinforced snowboard for flexural stiffness and resistance to torsional deformation. Other attempts have been made to improve snowboard flex stability. U.S. Pat. No. 6,102,428 to Bobrowicz appears to disclose a snowboard and binding combination having longitudinal lateral spars embedded in the snowboard with holes to hold binding mounting plates for spanning the spar separation and attaching a snowboard boot.

Attempts have been made to address interference between snowboard boots and gliding surfaces by inserting a spacer plate between snowboard and the snowboard binding. U.S. Pat. No. 6,505,841 to Kessler et al. appears to disclose a spacer for inserting between a snowboard and a snowboard binding to raise the binding from the snowboard mounting surface.

Devices such as those disclosed in the above-listed patents are undesirable to the snowboarder because their use does not promote stable binding orientation and promote snowboarding comfort. For example a snowboard having an embedded reinforcing structure may be more impervious to contortions and thus reduce distortion of the snowboard binding orientation, however the rigid snowboard is not able to flex and absorb forces imparted on the snowboard by features in the gliding surface, where the forces conduct through the rigid material to the operator causing an uncomfortable ride. Placing spacers made of shock absorption material between the independent bindings and snowboard have an undesirable effect of creating an unstable binding orientation.

What is needed and has been heretofore unavailable, is a device that creates a stable binding orientation, is light weight, durable, comprises no moving parts subject to wear or damage, capable of easy installation to a variety of snowboards and snowboard bindings and is adjustable for fitting to many snowboard binding spans.

### BRIEF DESCRIPTION OF THE DRAWINGS

FIGS. 1a and 1b depicts a perspective view of a prior art snowboard and snowboard binding system.

FIGS. 2a, 2b and 2c depict a planar rear view of a typical operation of a prior art snowboard system.

FIG. 3 depicts an exploded perspective cutaway view of a prior art snowboard system.

FIGS. 4a and 4b depict perspective views of a snowboard stability and damping system.

FIGS. 5a through 5d depict perspective views of the snowboard stability and damping system elements.

FIGS. 6a and 6b depicts the snowboard stability and damping system configured for operation on a snowboard.

### DETAILED DESCRIPTION

The current invention is a snowboard binding stability and dampening system providing an adjustable-length torque and flex dampening means for connecting a pair of snowboard bindings and limiting undesirable dynamics in a snowboard binding orientation associated with twisting and flexing of the snowboard, where elastic compressible material is inserted between the system and snowboard for dampening forces between the bindings and snowboard. The adjustable span snowboard stability and dampening system comprising a pair of stabilizing bars positioned in a cross configuration having ends for inserting to sockets of four retention housings mounted about two pivot plates secured to a snowboard for coplanar holding of a pair of snowboard bindings dampened by compression rings inserted between the pivot plates and the snowboard. Snowboard bindings are fixedly attached to the pivot plates using attachment means conventional with snowboard binding technologies.

The invention improves edge response stability and control of the snowboard by maintaining the snowboard bindings in a desirable orientation with the cross pair of torque and flex resistant bars attached to the pivot plates for holding the snowboard bindings to reduce twisting and bowing between the bindings. The crossbar design limits twisting and bowing and enables communication between opposing heal and toe forces applied to snowboard bindings for improved edge control. The span between the pivot plates is adjustable to accommodate a variety of existing binding spans and according to industry standards.

Elastic compression material is inserted between the pivot plates and snowboard. The pivot plates are fixedly attached to the snowboard to compress the compression material enabling dampening of forces between pivot plates and snowboard enabling a smoother ride and improved control while maintaining desirable binding orientation. The compression material may be a variety of shapes, heights, elasticity and hardness, for individualizing performance according to edge pressure preferences.

The snowboard binding stability and dampening system enables a snowboard operator to customize binding height and flex characteristics, for individualizing edge sensitivity, control and transfer rates, while increasing heel and toe pressure efficacy on snowboard edge pressure. The system improves ease in gliding during hill transverse (push with one foot attached to snowboard), and enables easier standing while stopped. Further, the snowboard binding stability and dampening system creates new versatility for tricks and new movements, and the flex in the compression material enables greater range of recovery during twists or falls by enabling one binding to communicate with the other binding for better performance and control. The current invention improves edge response, edge transfer rates and edge sensitivity, and enables individualizing torque, height and compression preferences.

As shown in the drawings for the purpose of illustration, the adjustable span snowboard stability and dampening system invention comprises a pair of stabilizing bars having, two pair of right-hand and left-hand retention housings for fixedly holding the stabilizing bars in a cross-orientation to a pair of pivot plates, and a pair of compression rings for inserting between the pivot plate and the snowboard. Conventional assembly hardware such as screws and threaded holes are used for combining the retention housings to the pivot plates and the pivot plates to the snowboard and the snowboard bindings to the pivot plates.

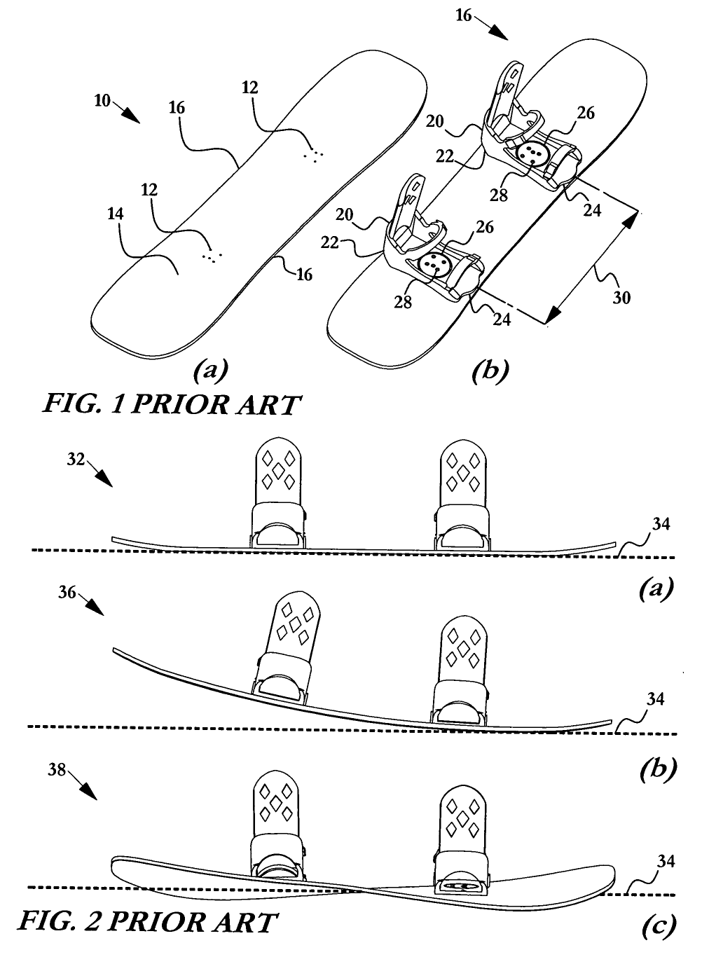

Referring now to the drawings, FIGS. 1a and 1b depict a typical operating environment for the current invention, where FIG. 1a is a perspective view of a prior art snowboard 10 having snowboard mounting holes 12 on a snowboard mounting surface 14 for fixedly attaching snowboard bindings (not shown), and snowboard edges 16 for controlling the snowboard 10. FIG. 1b is a perspective view of a prior art snowboard and snowboard bindings system 18, where the snowboard bindings 20 are fixedly attached to the snowboard mounting surface 14 using common attachment means. As shown, the snowboard bindings 20 comprise a snowboard binding heel 22 and snowboard binding toe 24 and a snowboard binding mounting plate 26 having snowboard binding mounting holes 28 for aligning with the snowboard mounting holes 12 and using a plurality mounting screws for fixedly attaching the snowboard binding 20 to the snowboard 10. As depicted, there exists a snowboard binding span 30 between the snowboard binding pair that is typically determined according to the operator's preference.

FIGS. 2a, 2b, and 2c depict typical operation of the prior art snowboard and bindings of FIG. 1a having binding orientations typical to snowboard operation, where an operator is not depicted for illustrative clarity. FIG. 2a is the snowboard and binding system in a standing position 32 for gliding across snow, ice or other gliding surfaces 34, where the snowboard binding mounting plates 26 are co-planar and in a desirable orientation. A dashed line depicts a gliding surface 34. In the standing position 32, the forces exerted by the operator on the snowboard are normal to the snowboard mounting surface, and the operator's weight is nearly evenly distributed between each snowboard binding 20 and across the snowboard binding toes 24 and heels 22.

FIG. 2b depicts a snowboard having a bowed contortion 36 causing an undesirable snowboard binding 20 orientation, where such contortions may be induced when the operator lifts one snowboard binding 20 upward while pressing downward on the other snowboard binding 20 or according to terrain features (not shown) in the gliding surface 34.

FIG. 2c depicts a twisted snowboard contortion 38 causing an undesirable snowboard binding 20 orientation, where the twisting contortion 38 may be induced when the operator presses with one snowboard binding toe 24 and presses with the opposite snowboard binding heel 22, or may be induced according to terrain features (not shown) in the gliding surface 34.

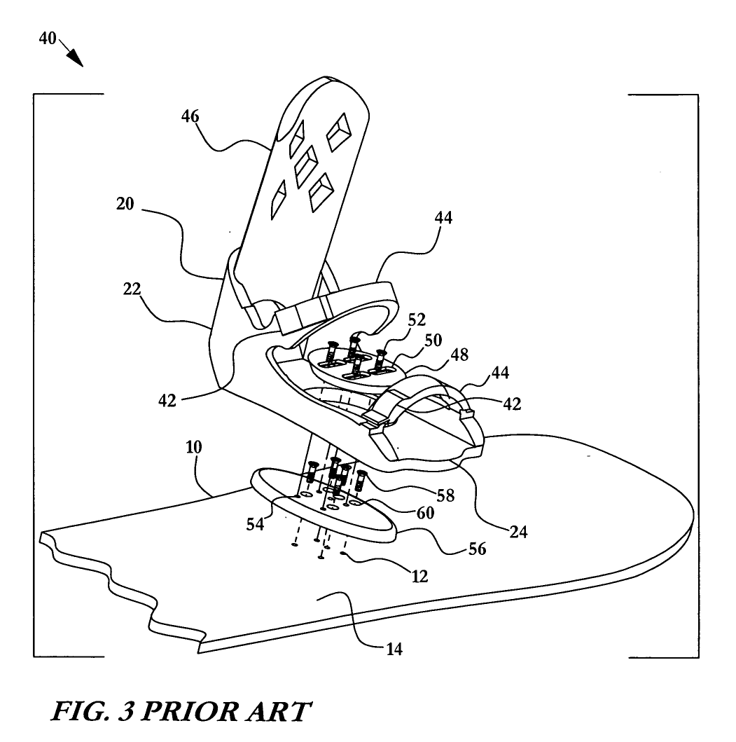

FIG. 3 depicts an exploded perspective view of a prior art binding assembly 40 typical with snowboard 10 use, where depicted is a snowboard binding 20 having a binding buckle 42 for tensioning and securing a binding strap 44 for fixedly holding a snowboard boot (now shown) to the snowboard binding 20. The snowboard binding 20 further comprises a snowboard binding heel 22 and a snowboard binding toe 24, and a binding heel support arm 46 for communicating with the snowboard boots (not shown). Further depicted is a slotted binding mounting plate 48 having slotted mounting plate holes 50 for adjustably attaching to a snowboard 10 according to the binding span 30. Binding mounting screws 52 are inserted through the slotted holes 50 and fixedly screwed into spacer binding holes 54 of a prior art spacer plate 56, where the spacer plate 56 is used to elevate the snowboard binding 20 from the snowboard mounting surface 14 and reduce snowboard binding 20 interference with the gliding surface 34 and to provide additional snowboard binding heel 22 and toe 24 leverage to the snowboard 10. Spacer mounting screws 58 are inserted through spacer mounting holes 60 and tightened into snowboard mounting holes 12 to fixedly attach the spacer 56 to the snowboard 10, where the snowboard binding 20 is fixedly attached to the spacer 56 at a desired binding span 30.

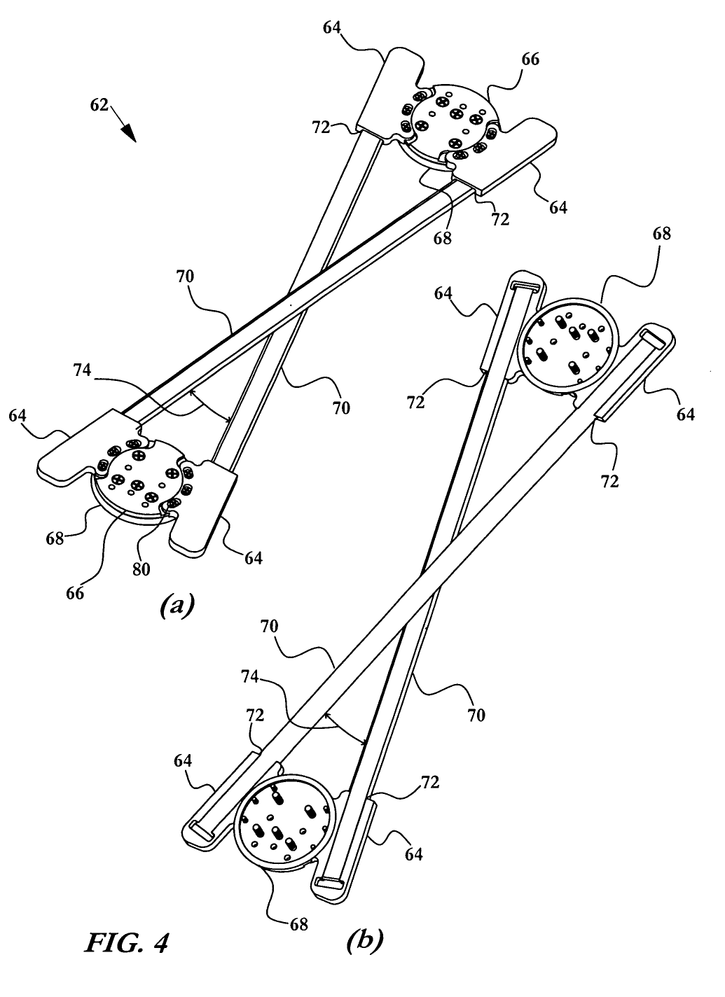

FIGS. 4a and 4b are top and bottom perspective views, respectively, depicting the adjustable span snowboard stability and dampening system 62 invention comprising two pair of right hand and left hand retention housings 64, a pair of pivot plates 66, a pair of compression rings 68 and a pair of stabilizer bars 70. The retention housings 64 are rotatably positioning about and fixedly mounting to the pivot plates 66, and are positioned for receiving and frictionally holding the stabilizer bars 70. The retention housings 64 are fixedly attached to the pivot plates 66 when the desired binding span 30 is attained, and a compression ring 68 is fixedly mounting between a snowboard 10 (not shown) and the pivot plate 66. The stabilizing bars 70 are positioned to cross one another where the ends of the stabilizer bars 70 are received by sockets 72 in the retention housing 64 to provide torsional and flex stability across the stabilizer bars 70 and between the pivot plates 66. The adjustable span snowboard stability and dampening system 62 invention may be adjusted to fit different binding spans 30 while the securing hardware of the system 62 are in a loosened configuration (not shown), the retention housings 64 are free to pivot about the pivot plates 66, and the stabilizer bars 70 are free to slide within the retention housing sockets 72. To expand the binding span 30, the pivot plates 66 are positioned away from each other causing the stabilizer bars 70 to slide outward from the retention housing sockets 72 and the cross angle 74 formed by the stabilizer bars 70 is made smaller, causing the retention housings 64 to pivot about the pivot plate 66. A sufficient length of the stabilizer bar 70 remains in the retention housing sockets 72 for fixidly holding and transferring forces when the securing hardware is tightened. Conversely, to reduce the binding span 30, the pivot plates 66 are positioned closer together causing the stabilizer bars 70 to slide inward to the retention housing sockets 72 and the cross angle 74 formed by the stabilizer bars is made larger, causing the retention housings 64 to pivot about the pivot plate 66 for accommodating the larger cross angle 74 formed by the stabilizer bars 70. The stabilizing bars 70, about ⅛ inch to ¾ inches in thickness, about ¾ inches to 1½ inches in width and about 20 inches to 30 inches in length are shaped to fittedly insert to the retention housing sockets 72, are made from extruded aluminum or other molded material having strength suitable to transfer forces between the snowboard bindings 20 to minimize deviations in the coplanar orientation of the snowboard bindings 20. The cross configuration of the stabilizer bars 70 have cross angles 74 determined by the binding span 30.

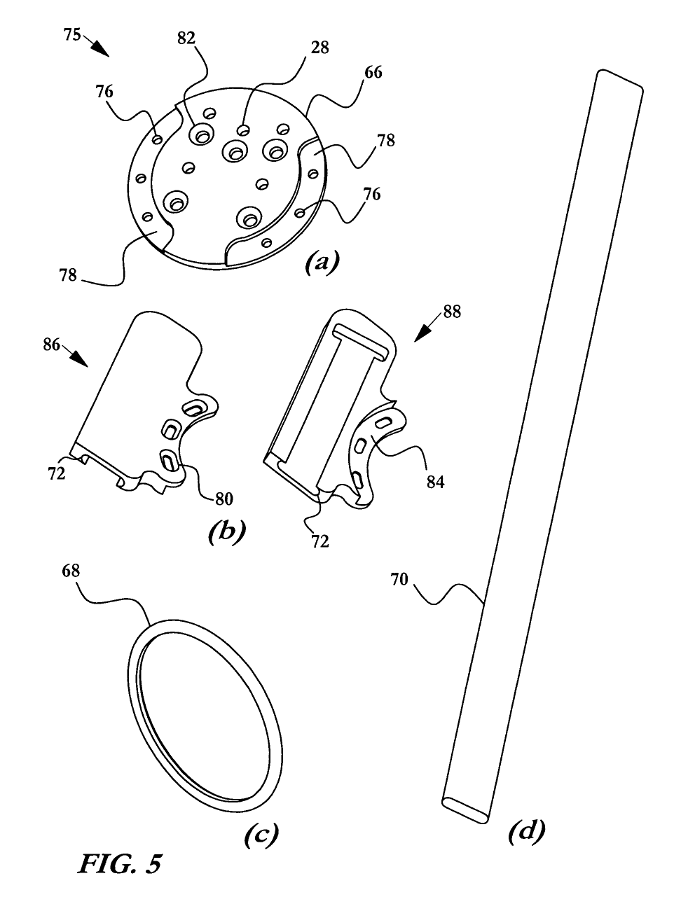

FIGS. 5a through 5e depict perspective views of the individual elements 75 of the adjustable span snowboard stability and dampening system 62 invention comprising a pivot plate 66, retention housings 64 (right hand and left hand), a compression ring 68 and a stabilizer bar 70, where redundant elements have been omitted for illustrative clarity.

The pivot plate 66 depicted in FIG. 5a is generally circular-planar in shape having threaded housing mounting holes 76 through semi-circular tiers 78 for receiving fastening screws inserted through arched mounting screw slots 80 in the retention housings 64 and for fixedly tightening thereto. The pivot plate 66 is further depicted having snowboard binding mounting screw holes 28 for receiving binding mounting screws and fixedly securing snowboard bindings 20 thereto. Additionally depicted in the pivot plate 66 are oversized snowboard mounting through holes 82 for receiving snowboard mounting screws to fixedly fastening the pivot plate 66 to the snowboard mounting holes 12, where the oversized pivot plate mounting holes 82 are sufficiently oversized to enable the pivot plate 66 to slidably move along the snowboard mounting screws according to forces applied to the snowboard 10, compression rings 68 and snowboard bindings 20.

The retention housings 64 depicted in FIG. 5b are generally rectangular in shape having a retention housing socket 72 for receiving a stabilizer bar 70, and having an arched tier 84 for abutting to and rotatably positioning about the pivot plate semi-circular tiers 78. The retainer housings arched tiers 84 are fixedly attaching to the semi-circular tiers 78 of the pivot plates 66 in a right hand and left hand configuration, where the left hand retention housing 64 is depicted in a top perspective orientation 86 and the right hand retention housing 64 is depicted in a bottom perspective orientation 88. The retention housings 64 have a retention housing socket 72 for receiving the stabilizer bar 70, arched mounting screw slots 80 in and arched tier 84 enabling radial positioning and fixed securing of the retention housing 64 about the semi-circular tier 78 of the pivot plate 66. The retention housings 64 are adjustable about the pivot plate 66 from about 5 to 15 degrees.

The compression ring 68 depicted in FIG. 5c is for inserting between the pivot plate 66 and snowboard mounting surface 14 to enable damping of forces between the snowboard 10 and pivot plate 66. The compression rings 68 comprise an elastic material having hardness about 70 durometers to 140 durometers for dampening forces between snowboard 10 and pivot plate 66 having snowboard bindings 20 fixedly attached thereto. The compression rings 68 are about ⅛ inch to ¾ inches in thickness and about 3 inches to 5 inches in diameter having an open center. In an alternate embodiment, the compression rings 68 are cylindrical in shape and are about ⅛ inch to ¾ inches in thickness and about 3 inches to 5 inches in diameter having a closed center.

The stabilizing bar 70 in FIG. 5d has a profile suitable for inserting to the retention housing socket 72. The stabilizing bars 70 are about ⅛ inch to ¾ inches in thickness, about ¾ inches to 1½ inches in width and about 20 inches to 30 inches in length and are shaped to fittedly insert to the retention housing sockets 72. In one embodiment, the stabilizing bars 70 are made from extruded aluminum or other molded material having strength suitable to transfer forces between the snowboard bindings 20 to minimize deviations in the orientation of the coplanar orientation.

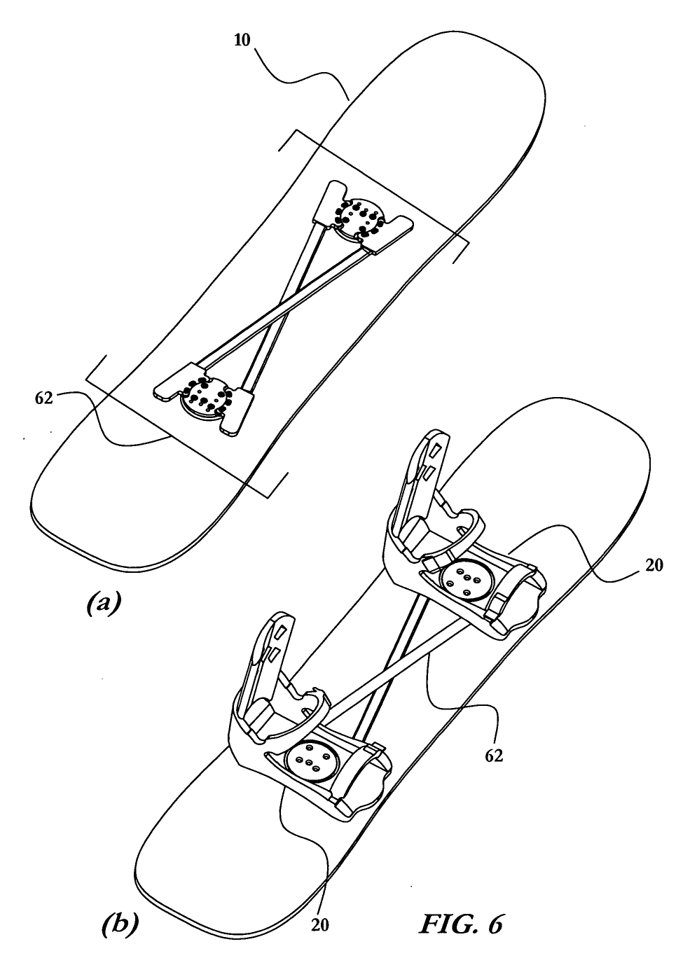

FIGS. 6a and 6b depict the adjustable span snowboard stability and dampening system 62 invention configured to a snowboard 10, where FIG. 6a depicts the adjustable span snowboard stability and dampening system 62 invention configured for receiving snowboard bindings 20 and FIG. 6b depicts the adjustable span snowboard stability and dampening system 62 invention having snowboard bindings 20 fixedly attached to the pivot plates 66.

The method of using the adjustable span snowboard stability and dampening system 62 comprising the steps of inserting a first end of a first stabilizer bar 70 to a socket 72 of a first right-hand retention housing 64 and inserting a second stabilizer bar end of the first stabilizer bar 70 to a socket 72 of second right-hand retention housing 64 and, inserting a first end of a second stabilizer bar 70 to a socket 72 of a first left-hand retention housing 64 and inserting a second stabilizer bar end of the second stabilizer bar 70 to a socket 72 of second left-hand retention housing 64. The arched tier 84 of the first right-hand retention housing 64 is abutted with a first semi-circular tier 78 in a first pivot plate 66 to align arched mounting screw slots 80 in the first right-hand retention housing 64 with threaded housing mounting holes 76 through a first semi-circular tier 78 in the first pivot plate 66 and inserting fastening screws there through for fixedly tightening at the desired position and, the arched tier 84 of the first left-hand retention housing 64 is abutted with a second semi-circular tier 78 in the first pivot plate 66 to align arched mounting screw slots 80 in the first left-hand retention housing 64 with threaded housing mounting holes 76 through a second semi-circular tier 78 in the pivot plate 66 and inserting fastening screws there through for fixedly tightening at the desired position. The arched tier 84 of the second right-hand retention housing 64 is abutted with a first semi-circular tier 78 in a second pivot plate 66 to align arched mounting screw slots 80 in the retention housing 64 with threaded housing mounting holes 76 through a first semi-circular tier 78 in the second pivot plate 66 and inserting fastening screws there through for fixedly tightening at the desired position. The arched tier 84 of the second left-hand retention housing 64 is abutted with a second semi-circular tier 78 in a second pivot plate 66 to align arched mounting screw slots 80 in the retention housing 64 with threaded housing mounting holes 76 through a second semi-circular tier 78 in the second pivot plate 66 and inserting fastening screws there through for fixedly tightening at the desired position. The pivot plates 66 are separated to a desired position for aligning oversized pivot plate mounting holes 82 with snowboard mounting holes 12 while the stabilizing bars 70 slide within the retention housing sockets 72 and the retention housings freely pivot about the pivot plates 66 as the stabilizing bars 70 have a varying crossing angle 74. The compression rings 68 are inserted between the pivot plate 66 and the snowboard mounting surface 14, where the pivot plates 66 are fixedly secured to the snowboard 10 using conventional mounting screws. The retention housings 64 are fixedly secured to the pivot plates 66 using conventional fastening screws and, the snowboard bindings 20 are fixedly secured to the pivot plates 66 using conventional fastening screws for snowboard operation.

These embodiments are set forth by way of example and are not for the purpose of limiting the present invention. It will be readily apparent to those skilled in the art that obvious modifications, derivations and variations can be made to the embodiments without departing from the scope of the invention. Accordingly, the claims appended hereto should be read in their full scope including any such modifications, derivations and variations.

1) An adjustable span snowboard stability and dampening system comprising a pair of stabilizing bars positioned in a cross configuration having ends for inserting to sockets of four retention housings mounted about two pivot plates secured to a snowboard for coplanar holding of a pair of snowboard bindings dampened by compression rings inserted between the pivot plates and the snowboard.

2) The adjustable span snowboard stability and dampening system of claim 1 where the stabilizing bars are about ⅛ inch to ¾ inches in thickness, about ¾ inches to 1½ inches in width and about 20 inches to 30 inches in length and are shaped to fittedly insert to the retention housing sockets.

3) The stabilizing bars of claim 2 are made from extruded aluminum or other molded material having strength suitable to transfer forces between the snowboard bindings to minimize deviations in the orientation of the coplanar bindings.

4) The adjustable span snowboard stability and dampening system of claim 1 where the cross configuration of the stabilizer bars have angles of intersection determined by the adjustable pivot plate span.

5) The adjustable span snowboard stability and dampening system of claim 1 where the retention housings are generally rectangular in shape having a retention housing socket for receiving a stabilizer bar, and having an arched tier for rotatably positioning about the pivot plates having pivot plate semi-circular tiers for receiving the retainer housing arched tiers and fixedly attaching thereto.

6) The retention housing of claim 5 further comprises arched mounting screw slots in the arched tier enabling radial positioning and fixed securing of the retention housing about the pivot plate semi-circular tier.

7) The retention housings of claim 5 further comprise right hand and left hand housings for symmetric positioning about a pivot plate and are made from aluminum or other lightweight material having sufficient material strength.

8) The adjustable span snowboard stability and dampening system of claim 1 where the pivot plates are generally circular-planar in shape having threaded mounting holes through the semi-circular tier for receiving fastening screws inserted through the arched mounting screw slots in the retainer housings and for fixedly tightening thereto.

9) The pivot plate of claim 8 further comprises threaded snowboard binding mounting screw holes for receiving binding mounting screws and fixedly securing snowboard bindings thereto.

10) The pivot plate of claim 8 further comprises oversized snowboard mounting through holes for receiving snowboard mounting screws fixedly fastened to the snowboard.

11) The oversized snowboard mounting through holes of claim 10 enable the pivot plate to slidably move along the snowboard mounting screws according to forces applied to the snowboard, compression rings and snowboard bindings.

12) The adjustable span snowboard stability and dampening system of claim 1 where the compression rings comprise an elastic material having hardness about 70 durometers to 140 durometers for dampening forces between snowboard and snowboard bindings.

13) The compression rings of claim 12 are about ⅛ inch to ¾ inches in thickness and about 3 inches to 5 inches in diameter having an open center.

14) The compression rings of claim 12 are cylindrical in shape and are about ⅛ inch to ¾ inches in thickness and about 3 inches to 5 inches in diameter having a closed center.

15) A method of using an adjustable span snowboard stability and dampening system having a pair of stabilizing bars positioned in a cross configuration having ends for inserting to sockets of four retention housings mounted about two pivot plates secured to a snowboard for coplanar holding of a pair of snowboard bindings dampened by compression rings inserted between the pivot plates and the snowboard comprising the steps of:
a. inserting a first end of a first stabilizer bar to a socket of a first right-hand retention housing and inserting a second stabilizer bar end of the first stabilizer bar to a socket of second right-hand retention housing; and,
b. inserting a first end of a second stabilizer bar to a socket of a first left-hand retention housing and inserting a second stabilizer bar end of the second stabilizer bar to a socket of second left-hand retention housing; and,
c. abutting an arched tier of the first right-hand retention housing with a first semi-circular tier in a first pivot plate to align arched mounting screw slots in the first right-hand retention housing with threaded mounting holes through a first semi-circular tier in the first pivot plate and inserting fastening screws there through for fixedly tightening at the desired position; and,
d. abutting an arched tier of the first left-hand retention housing with a second semi-circular tier in the first pivot plate to align arched mounting screw slots in the first left-hand retention housing with threaded mounting holes through a second semi-circular tier in the pivot plate and inserting fastening screws there through for fixedly tightening at the desired position; and,
e. abutting an arched tier of the second right-hand retention housing with a first semi-circular tier in a second pivot plate to align arched mounting screw slots in the retention housing with threaded mounting holes through a first semi-circular tier in the second pivot plate and inserting fastening screws there through for fixedly tightening at the desired position; and,
f. abutting an arched tier of the second left-hand retention housing with a second semi-circular tier in a second pivot plate to align arched mounting screw slots in the retention housing with threaded mounting holes through a second semi-circular tier in the second pivot plate and inserting fastening screws there through for fixedly tightening at the desired position; and,
g. separating the pivot plates to a desired separation for aligning pivot plate mounting holes with snowboard mounting holes while the stabilizing bars slide within the retention housing sockets and the retention housings pivot about the pivot plates as the stabilizing bars have a varying crossing angle; and
h. inserting compression rings between the pivot plate and the snowboard and fixedly securing the pivot plates to the snowboard using snowboard mounting screws; and
i. fixedly securing the retention housings to the pivot plates using the fastening screws; and
j. fixedly securing snowboard bindings to the pivot plates for snowboard operation.
